(19) United States
(12) Patent Application Publication
(10) Pub. No.: US 2023/0118568 A1
(43) Pub. Date: Apr. 20, 2023

(54) TRUSTED GAMING TRANSACTIONS USING BLOCKCHAIN TECHNOLOGY

(71) Applicant: BlokPax LLC, Columbia, SC (US)

(72) Inventor: David Guy, Columbia, SC (US)

(21) Appl. No.: 17/967,268

(22) Filed: Oct. 17, 2022

Related U.S. Application Data
(60) Provisional application No. 63/256,033, filed on Oct. 15, 2021.

(51) Int. Cl. G07F 17/32; G06Q 20/36; G06Q 20/40

(52) U.S. Cl. CPC G07F 17/3241; G07F 17/3244; G07F 17/323; G06Q 20/3676; G06Q 20/401; G07F 17/3288; G06Q 2220/00

(57) ABSTRACT

Systems and methods for trusted gaming transactions using blockchain technology, including creating a smart contract defining terms of a particular gaming transaction using a blockchain, activating the smart contract once a threshold amount of game tokens are purchased by participants, and providing a secure game token transferring interface and platform configured to utilize a blockchain protocol to verify ownership and authenticity of the game tokens prior to enabling transferring of the game token from one participant to another participant. A status of the event is monitored using the smart contract, and a payout is initiated to a digital wallet of one or more winning participants by the smart contract upon the occurrence or non-occurrence of a triggering event.

### RELATED APPLICATION INFORMATION

This application claims priority to U.S. Provisional Patent Application No. 63/256,033, filed on Oct. 15, 2021, incorporated herein by reference in its entirety.

### BACKGROUND

### Technical Field

The present invention relates to gaming transactions and contests, and more particularly to conducting and participating in online contests/gaming transactions with increased trust levels for users participating in the gaming transactions and contests using smart contracts and/or blockchain technology.

### Description of the Related Art

Online and offline gaming transactions currently face two major constraints. First, any party entering into a transaction must trust that the opposing parties both (a) have the funds that they have wagered and (b) will surrender those funds as promised if and when the first party wins the wager. This has the effect of limiting the parties with whom one might enter into a gaming contract. In practice, this often means that parties are only willing to enter into gaming transactions with large institutions with public reputations (e.g., a large casino) or individuals or businesses personally known to the party (e.g., a friend, colleague, etc.). Second, assuming opposing parties have achieved trust in the other party, once a party enters a gaming transaction (e.g., by purchasing a stake/token/etc.), no system or process currently exists to provide any updated valuation of the stake/token and/or to securely trade or sell the stake in the transaction to a new party at any time during the gaming transaction.

### SUMMARY

According to an aspect of the present invention, a method is provided for trusted gaming transactions using blockchain technology, including creating a smart contract defining terms of a particular gaming transaction using a blockchain, activating the smart contract once a threshold amount of game tokens are purchased by participants, and providing a secure game token transferring interface and platform configured to utilize a blockchain protocol to verify ownership and authenticity of the game tokens prior to enabling transferring of the game token from one participant to another participant. A status of the event is monitored using the smart contract, and a payout is initiated to a digital wallet of one or more winning participants by the smart contract upon the occurrence or non-occurrence of a triggering event.

According to another aspect of the present invention, a system is provided for trusted gaming transactions using blockchain technology, and includes a processor device operatively connected to a computer-readable medium and configured to access a blockchain. The processor device creates a smart contract defining terms of a particular gaming transaction using a blockchain, activates the smart contract once a threshold amount of game tokens are purchased by participants, and provides a secure game token transferring interface and platform configured to utilize a blockchain protocol to verify ownership and authenticity of the game tokens prior to enabling transferring of the game token from one participant to another participant. A status of the event is monitored using the smart contract, and a payout is initiated to a digital wallet of one or more winning participants by the smart contract upon the occurrence or non-occurrence of a triggering event.

A non-transitory computer readable storage medium including a computer readable program operatively coupled to a processor device for trusted gaming transactions using blockchain technology, wherein the computer readable program when executed on a computer causes the computer to perform the steps of creating a smart contract defining terms of a particular gaming transaction using a blockchain, activating the smart contract once a threshold amount of game tokens are purchased by participants, and providing a secure game token transferring interface and platform configured to utilize a blockchain protocol to verify ownership and authenticity of the game tokens prior to enabling transferring of the game token from one participant to another participant. A status of the event is monitored using the smart contract, and a payout is initiated to a digital wallet of one or more winning participants by the smart contract upon the occurrence or non-occurrence of a triggering event.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 shows an exemplary processing system to which the present principles may be applied, in accordance with embodiments of the present invention;

FIG. 2 is a block/flow diagram showing a method for conducting and participating in online contests/gaming transactions with increased trust levels using smart contracts and/or blockchain technology, in accordance with embodiments of the present invention;

FIG. 3 is a block/flow diagram showing a method for conducting and participating in online contests/gaming transactions with long-term betting options with increased trust levels using smart contracts and/or blockchain technology, in accordance with embodiments of the present invention;

FIG. 4 is a block/flow diagram showing a method for conducting and participating in online contests/gaming transactions with multi-event and/or parlay betting options with increased trust levels using smart contracts and/or blockchain technology, in accordance with embodiments of the present invention;

FIG. 5 is a block/flow diagram showing a method for conducting online contests/gaming transactions with daily fantasy sports (e.g., fantasy football, fantasy baseball, etc.) betting options with increased trust levels using smart contracts and/or blockchain technology, in accordance with an embodiment of the present invention;

FIG. 6 is a block/flow diagram showing a method for conducting online contests/gaming transactions with long-term (e.g., days, week, month, season, etc.) fantasy sports (e.g., fantasy football, fantasy baseball, etc.) betting options with increased trust levels using smart contracts and/or blockchain technology, in accordance with an embodiment of the present invention;

FIG. 7 is a diagram showing a system for conducting and participating in online contests/gaming transactions with increased trust levels using smart contracts and/or blockchain technology, in accordance with embodiments of the present invention; and

FIG. 8 is a diagram showing an exemplary high-level system and method for conducting and participating in online contests/gaming transactions with increased trust levels using smart contracts and/or blockchain technology, in accordance with embodiments of the present invention.

### DETAILED DESCRIPTION

In accordance with embodiments of the present invention, systems and methods are provided for conducting online contests with increased trust levels for users participating in the online gaming transactions and contests using smart contracts and/or blockchain technology.

In various embodiments, the present invention can provide real-time updated information (e.g., current odds, updated stake/entry token value, etc.) during a gaming transaction for utilization by users/contestants to determine whether to trade or sell a stake/entry token for the gaming transaction at any time. There are many scenarios whereby one of the parties may wish to exit a gaming transaction, potentially with a gain or loss, depending on the circumstances of the gaming event. For example, scenarios where parties may desire to exit the gaming transaction prior to completion may include, but are not limited to the following: (1) lock in a gain, (2) cut your losses, (3) double down/cost average, (4) hedge your bets, etc. The present invention provides a secure mechanism for any party to a gaming transaction to market, trade, and/or sell its interest (e.g., stake, entry token, etc.) in the transaction at any time (e.g., prior to the start of the gaming event, during the gaming event, etc.), to any other user, in accordance with aspects of the present invention.

The inventive systems and methods described hereinbelow address both the trust issue and the liquidity issue (e.g., trading, selling, etc.) described above, thereby opening the possibility that parties would be able to engage in gaming transactions with a much broader range of counterparties and allowing for parties to enter and exit transactions with significantly less friction and/or possibility for fraud and/or non-payment to winning users.

As will be appreciated by one skilled in the art, aspects of the present invention may be embodied as a system, method or computer program product, which can be executed on public or private blockchains that are accessible from a local or remote computing device. Accordingly, aspects of the present invention may take the form of an entirely hardware embodiment, an entirely software embodiment (including firmware, resident software, micro-code, etc.) or an embodiment combining software and hardware aspects. Furthermore, embodiments of the present invention may take the form of a computer program product embodied in one or more computer readable medium(s) on one or more computing devices having computer readable program code embodied thereon. Embodiments described herein may be entirely hardware, entirely software or including both hardware and software elements. In some embodiments, the present invention is implemented in software, which includes but is not limited to firmware, resident software, microcode, etc., in accordance with aspects of the present invention.

Any combination of one or more computer readable medium(s) may be employed. The computer readable medium may be a computer readable signal medium or a computer readable storage medium. A computer readable storage medium may be, but is not limited to, an electronic, magnetic, optical, electromagnetic, infrared, or semiconductor system, apparatus, or device, or any combination thereof. Other examples of the computer readable storage medium may include, but are not limited to, an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any combination thereof. In this document, a computer readable storage medium may be any tangible medium that can contain, or store a program for use by or in connection with a computing system, apparatus, or device.

Program code embodied on a computer readable medium may be transmitted using any suitable medium, including but not limited to wireless, wireline, optical fiber cable, etc., or any combination thereof. Computer program code for carrying out operations for aspects of the present invention may be written in any combination of one or more programming languages, including, but not limited to any general-purpose programing language (e.g., PHP, Java, C++, etc.) and/or domain-specific programing language (e.g., HTML, SQL, etc.), blockchain-specific programming language (e.g., solidity, rust, java, python, etc.). The program code may execute fully on the user's computer/mobile device, partially on the user's computer/mobile device, as stand-alone software, partially on the user's computer/mobile device and partially on a remote computer/mobile device, entirely on a remote computer or server, and/or using blockchain. The remote computer may be connected to the user's computer through any type of network (e.g., a local area network (LAN), wide area network (WAN), a connection to an external computer (e.g., over the Internet using an Internet Service Provider), etc.).

Aspects of the present invention are described below with reference to flowchart illustrations and/or block diagrams of methods, systems and computer program products according to embodiments of the present invention. It is noted that each block of the flowcharts and/or block diagrams, and combinations of blocks in the flowcharts and/or block diagrams, may be implemented by computer program instructions.

These computer program instructions may be sent to a processor of any type of computing system (e.g., general purpose computer, special purpose computer, or other programmable data processing apparatus to produce a machine), such that the instructions, which execute by the processor of the computing system, create a means for implementing the functions/instructions/acts specified in the flowcharts and/or block diagram block or blocks. These computer program instructions may also be stored in a computer readable medium that can instruct any computing device to function in a particular manner, such that the instructions stored in the computer readable medium produce an article of manufacture including instructions which implement the function/instruction/act specified in the flowchart and/or block diagram block or blocks.

The computer program instructions may also be loaded onto a computer, mobile device, other programmable data processing apparatus, or other devices to cause a series of operational steps to be performed on any computing system to produce a computer implemented process such that the instructions which execute on the computer or other programmable apparatus provide processes for implementing the functions/acts specified in the flowcharts and/or block diagram block or blocks.

A computer readable signal medium may include a propagated data signal with computer readable program code embodied therein (e.g., baseband, part of a carrier wave, etc.). Such a propagated signal may take any of a variety of forms, including, but not limited to, electro-magnetic, optical, or any combination thereof. A computer readable signal medium may be any computer readable medium that is not a computer readable storage medium and that can communicate, propagate, or transport a program for use by or in connection with a computing system, apparatus, or device.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems, remote printers, storage devices, blockchain, etc. through intervening private or public networks. Modems, cable modem and Ethernet cards are just a few of the currently available types of network adapters.

The flowchart and block diagrams in the figures illustrate the architecture, functionality, and operation of possible implementations of systems, methods and computer program products according to various embodiments of the present invention. Each block in the flowchart or block diagrams may represent a module, segment, or portion of code, which comprises one or more executable instructions for implementing the specified logical function(s), and in some alternative implementations of the present invention, the functions noted in the block may occur out of the order noted in the figures. For example, two blocks shown in succession may, in fact, be executed substantially concurrently, may sometimes be executed in reverse order, or may be executed in any other order, depending on the functionality of a particular embodiment.

It is also noted that each block of the block diagrams and/or flowchart illustration, and combinations of blocks in the block diagrams and/or flowchart illustration, can be implemented by specific purpose hardware systems that perform the specific functions/acts, or combinations of special purpose hardware and computer instructions according to the present principles.

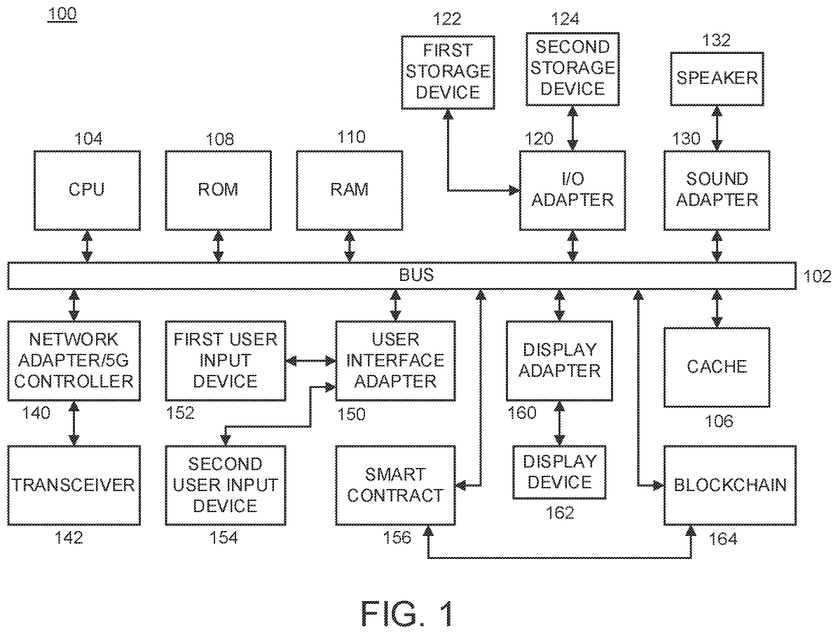

Referring now to the drawings in which like numerals represent the same or similar elements and initially to FIG. 1, an exemplary processing system 100, to which the invention principles may be applied, is illustratively depicted in accordance with embodiments of the present invention. The processing system 100 can include at least one processor (CPU) 104 operatively coupled to other components via a system bus 102. A cache 106, a Read Only Memory (ROM) 108, a Random Access Memory (RAM) 110, an input/output (I/O) adapter 120, a sound adapter 130, a network adapter 140, a user interface adapter 150, and a display adapter 160, can be operatively coupled to the system bus 102.

A first storage device 122 and a second storage device 124 can be operatively coupled to system bus 102 by the I/O adapter 120. The storage devices 122 and 124 can be any of a disk storage device (e.g., a magnetic or optical disk storage device), a solid-state magnetic device, and so forth. The storage devices 122 and 124 can be the same type of storage device or different types of storage devices.

A speaker 132 can be operatively coupled to system bus 102 by the sound adapter 130. The speaker 132 can be used to provide an audible alarm or some other indication relating to resilient battery charging in accordance with the present invention. A transceiver 142 can be operatively coupled to system bus 102 by network adapter 140. A display device 162 can be operatively coupled to system bus 102 by display adapter 160.

A first user input device 152 and a second user input device 154 can be operatively coupled to system bus 102 by user interface adapter 150. The user input devices 152, 154 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present invention. The user input devices 152, 154 can be the same type of user input device or different types of user input devices. The user input devices 152, 154 can be used to input and output information to and from system 100. The system 100 can be implemented using the blockchain 164, and can include one or more smart contracts 156 which can be utilized to manage contests/gaming transactions on the blockchain 164, in accordance with aspects of the present invention.

Of course, the processing system 100 may also include other elements (not shown), as readily contemplated by one of skill in the art, as well as omit certain elements. For example, various other input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present invention provided herein.

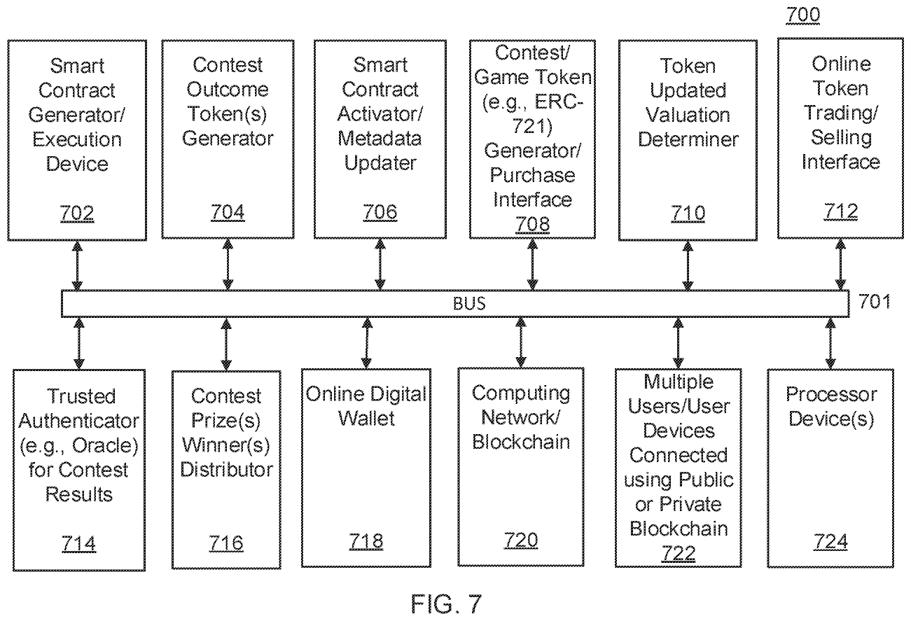

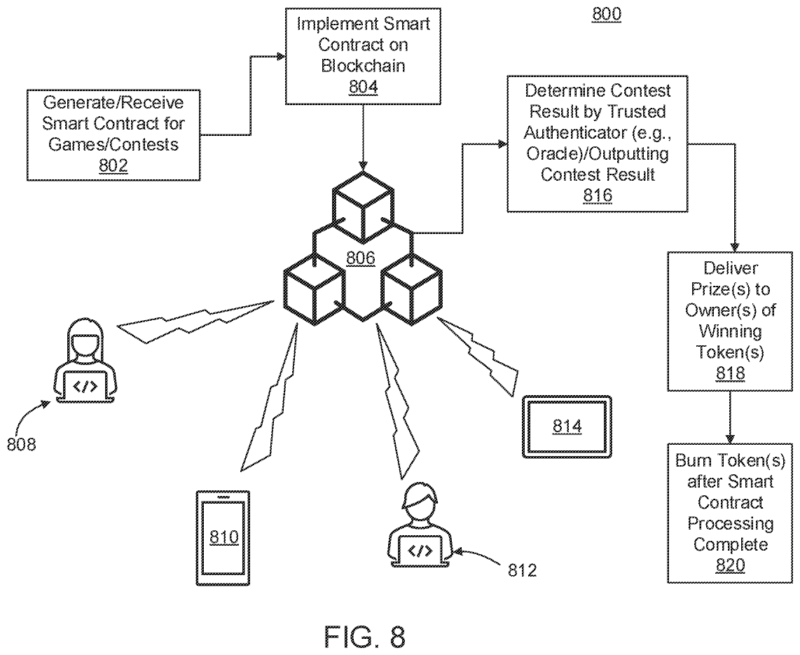

Moreover, it is to be appreciated that systems 700 and 800, described below with respect to FIGS. 7 and 8, respectively, are systems for implementing respective embodiments of the present invention. Part or all of processing system 100 may be implemented in one or more of the elements of systems 700 or 800 of FIGS. 7 and 8, respectively.

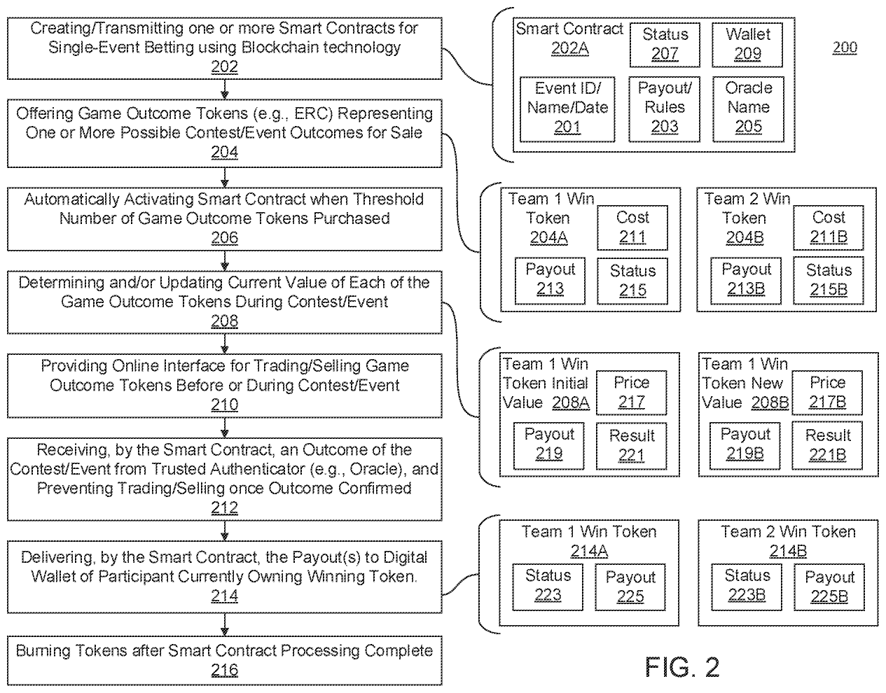

Further, it is to be appreciated that processing system 100 may perform at least part of the methods described herein including, for example, at least part of methods 200, 300, 400, 500, 600, and 800 of FIGS. 2, 3, 4, 5, 6, and 8, respectively. Similarly, part or all of systems 700 and 800 of FIGS. 7 and 8, respectively, may be used to perform at least part of methods 200, 300, 400, 500, 600, and 800 of FIGS. 2, 3, 4, 5, 6, and 8, respectively.

Referring now to FIG. 2, a block/flow diagram showing a method 200 for conducting and participating in online contests/gaming transactions with increased trust levels for users participating in the contests/gaming transactions using smart contracts and/or blockchain technology, is illustratively depicted in accordance with an embodiment of the present invention.

In some embodiments, the present invention utilizes blockchain technology to ensure that all of a multiple number of parties entering into a gaming transactions have the requisite trust that opposing parties will perform as contracted, and that all of the parties entering into a gaming transaction have the opportunity to sell or trade their interest in the transaction at any point between the time the transaction is entered and the time the wager is paid out, in accordance with aspects of the present invention.

In an embodiment, a Smart Contract (e.g., ERC-721 token on the Ethereum network or similar) that defines the terms of the transaction can be created and/or transmitted to one or more contest participants for single-event betting using blockchain technology in block 202.

For illustrative purposes, an exemplary Smart Contract 202A can include, for example, one or more of the following:
a. Event Details in block 201, which can include, for example:
   i. Event Date and time: (e.g., 8/8/2022, 8:00 pm EST)
   ii. Type: (e.g., Individual Game Winner)
   iii. Parties: (e.g., New York Yankees, Boston Red Sox);
b. Outcomes including payouts and contest rules in block 203, which can include, for example:
   i. Yankees win
   ii. Red Sox win
   iii. Canceled/Postponed (Each party returned its entry amount)
   iv. Payout amount for winner (e.g., x Ethereum (ETH));
c. A trusted Authenticator of game results (e.g., Reference Oracle) in block 205, can be utilized for increasing trust in contest/gaming transactions between users, in accordance with aspects of the present invention. Oracles are data sources for a blockchain which support smart contract protocols (e.g., Ethereum) and can be referenced to determine if a predefined condition has been met, thus triggering and on-chain action. For example, prediction market applications can use oracles to determine whether a predetermined condition has been met for a particular event, and as a result settle payments based on the occurrence of the particular event. A prediction market may ask a user to bet Ethereum (ETH) on the election outcome for the next president of the United States, and can use an oracle (or other trusted authentication authority) to confirm the outcome and pay out to the winners. The outcome/payout can be specified in the smart contract 202A, and can execute upon satisfaction of one or more predetermined conditions, as specified by the Smart Contract 202A. An exemplary oracle 205 for the above baseball game example can be:
   i. MLB Individual Game Results Oracle;
d. A Smart Contract status in block 207, which can include, for example, designations such as offered contract, percentage of entries remaining, pending, paid, etc., in accordance with aspects of the present invention; and
e. Wallet holdings in block 209, which can represent a total amount of funding (e.g., ETH) required from users for entry into the contest/gaming transaction and can trigger the execution of the Smart Contract 202A when the total amount is reached, in accordance with aspects of the present invention.

In some embodiments, game outcome tokens 204A, 204B (e.g., ERC-721 tokens) can be offered for sale for a contest/gaming transaction representative of one or more possible contest/event outcomes in block 204. When a participant purchases/accepts the transaction, the initial token cost 211, 211B (e.g., entry fee) can be immediately charged and held by the Smart Contract 202A, and a Game Token (e.g., Team 1 Win —204A, Team 2 Win —204B) can be placed into the digital wallet (not shown) of the participant. A status 215, 215B (e.g., pending, won, lost, etc.) of the game outcome tokens 204A, 204B for the contest/event can be included in the game outcome tokens 204A, 204B, in accordance with aspects of the present invention. The outcomes under which the holder of one or more Game Tokens 204A, 204B receives a payout 213, 213A for a win (or a limited or no payout for a loss) can be defined and governed by the Smart Contract by the payout/rules in block 203.

In some embodiments, once all of a threshold amount (e.g., 50%, 75%, 100%, etc.) of Game Tokens 204A, 204B have been purchased by users, and all entries fees have been paid to the Wallet 209, the Smart Contract 202A can be automatically activated and can confirm that the game is now active in block 206. Predetermined payout amounts from block 203 can be delivered by to one or more respective owners of one or more winning tokens upon satisfaction of predetermined conditions of the Smart Contract 202A, and if the predetermined conditions do not occur, the Smart Contract 202A can execute one or more other predetermined actions (e.g., no payout, less payout, etc.) according to the payout/rules in block 203, in accordance with aspects of the present invention.

In block 208, a current value of each of the game outcome tokens 204A, 204B can be iteratively determined (e.g., based on determined probabilities, time left in game, injury to a player, etc.) during the contest/event, and a value of the game outcome tokens 204A, 204B can be updated accordingly and the win token initial value 208A, and can include a payout amount 219, an initial purchase price 217, and a designation of a winning result 221 (e.g., Yankees win). The initial token value 208A can be updated in block 208 to reflect a determined new token value 208B, which can include a payout amount 219B, an updated sale price 217B (e.g., higher or lower price than initial), and a designation of a winning result 221B (e.g., Yankees win), in accordance with aspects of the present invention.

In some embodiments, after the Smart Contract 202A is executed, each game token 204A, 204B can represent one or more attributes and/or outcomes which singularly or in combination with other game tokens can serve as entries into the contest. The game tokens 204A, 204B can be marketed/sold/transferred by their owners at any time, without limitation, during or before the contest/event, and an interface for marketing/selling/transferring game tokens 204A, 204B can be provided in block 210. The token marketing/selling/transferring interface of block 210 can enable a user/participant to sell their interest (e.g., game tokens 204A, 204B) before or during the related event. Since the Smart Contract 202A can exist on the blockchain, there can be a clear record of ownership of all game tokens 204A, 204B. Further, the attributes and/or outcome combinations which may (or may not) result in the owners of the game tokens 204A, 204B (or combination of game tokens 204A, 204B) receiving a payout upon outcome of the contest can be predefined by the Smart Contract 202A and thus known to users/participants upon entry into the contest, thereby increasing trust in the transactions.

In various embodiments, an outcome of the contest/event can be received by the Smart Contract 202A from a trusted authenticator (e.g., Oracle) in block 212. In some embodiments, trading and/or selling game tokens can be prevented/blocked by the terms of the Smart Contract 202A once the outcome of an event is confirmed. In block 214, upon the occurrence/satisfaction of a predefined trigger event (e.g., as defined in the Smart Contract 202A), winning token(s) and/or owners of winning token(s) can be determined as per the terms of the Smart Contract 202A, which may be less any transaction fee or service fee charged as part of the Smart Contract transaction, in accordance with aspects of the present invention. In some embodiments, a request for a transfer (e.g., buy, sell, trade) of the game tokens can be automatically generated upon a determined change in value of one or more game tokens reaching a predefined, participant-set threshold selling or buying price for particular tokens, in accordance with aspects of the present invention.

In some embodiments, metadata of the Game Tokens 204A, 204B can be updated upon occurrence/satisfaction of one or more trigger events to reflect current status 223, 223B (e.g., win, loss, paid, etc.) and/or payout amount 225, 225B for one or more winning tokens (e.g., Team 1 Win token—214A, Team 2 win token 214B), in accordance with aspects of the present invention. In block 216, after the processing by the Smart Contract 202A is complete, the operator or Smart Contract 202A may record further updates to the metadata of the tokens 204A, 204B, and/or burn (e.g., invalidate, destroy, etc.) the game tokens 204A, 204B, 214A, 214B as a way to reflect and/or communicate the outcome of the game to participants. In some embodiments, tokens 204A, 204B may also remain unchanged and can be used in other games by owners of the game tokens, in accordance with aspects of the present invention. It is noted that although the above-described method is illustratively depicted with respect to a baseball game with two (2) tokens sold and utilized, it is to be appreciated that the present principles can be applied to any event with any number of tokens sold and utilized, in accordance with various aspects of the present invention.

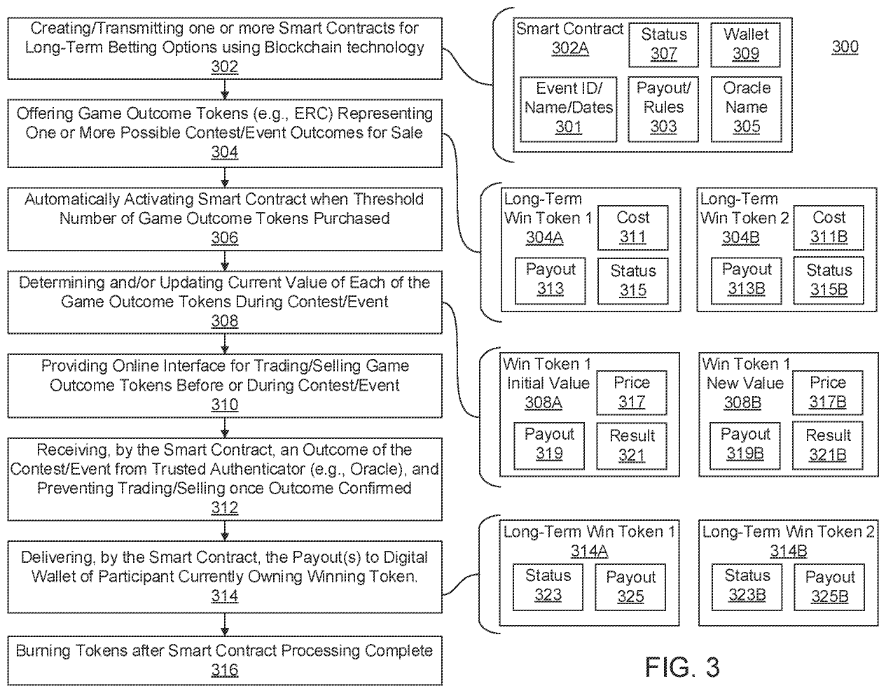

Referring now to FIG. 3, a block/flow diagram showing a method 300 for conducting and participating in online contests/gaming transactions with long-term betting options with increased trust levels for users participating in the contests/gaming transactions using smart contracts and/or blockchain technology, is illustratively depicted in accordance with an embodiment of the present invention.

In an embodiment, a Smart Contract (e.g., ERC-721 token on the Ethereum network or similar) that defines the terms of the transaction can be created and/or transmitted to one or more contest participants for long-term betting using blockchain technology in block 302.

For illustrative purposes, an exemplary Smart Contract 302A can include, for example, one or more of the following:
a. Event Details in block 301, which can include, for example:
   i. Event Date and time: (e.g., 2022 MLB Regular Season)
   ii. Type: (e.g., Over/Under a threshold number (e.g., 44) of Home Runs for the 2022 Season) iii. Parties: (e.g., Shohei Ohtani—MLB player);
b. Outcomes including payouts and contest rules in block 303, which can include, for example:
   i. Shohei Ohtani hits 45 Home Runs=win
   ii. Shohei Ohtani hits 43 Home Runs=loss
   iii. Shohei Ohtani hits exactly 44 Home Runs=no winner
   iv. Payout amount for winner(s) (e.g., x Ethereum (ETH))—Note that the above-mentioned outcomes, rules, payouts, and/or triggering events of the Smart Contract 302A can be customized for any of a plurality of different outcomes, rules, payouts, and/or triggering events, in accordance with various aspects of the present invention;
c. A trusted Authenticator of game results (e.g., Reference Oracle) in block 305, can be utilized for increasing trust in contest/gaming transactions between users, in accordance with aspects of the present invention. Oracles are data sources for a blockchain which support smart contract protocols (e.g., Ethereum) and can be referenced to determine if a predefined condition has been met (e.g., hitting 44 Home Runs), thus triggering and on-chain action. For example, prediction market applications can use oracles to determine whether a predetermined condition has been met for a particular event, and as a result settle payments based on the occurrence of the particular event. A prediction market may ask a user to bet Ethereum (ETH) on the election outcome for the next president of the United States, and can use an oracle (or other trusted authentication authority) to confirm the outcome and pay out to the winners. The outcome/payout can be specified in the smart contract 302A, and can execute upon satisfaction of one or more predetermined conditions, as specified by the Smart Contract 302A. An exemplary oracle 305 for the above baseball Over/Under Season Home Run example can be:
   i. MLB Player Statistics Oracle;
d. A Smart Contract status in block 307, which can include, for example, designations such as offered contract, percentage of entries remaining, pending, paid, etc., in accordance with aspects of the present invention; and
e. Wallet holdings in block 309, which can represent a total amount of funding (e.g., ETH) required from users for entry into the contest/gaming transaction and can trigger the execution of the Smart Contract 302A when the total amount is reached, in accordance with aspects of the present invention.

In some embodiments, Long-Term game outcome tokens 304A, 304B (e.g., ERC-721 tokens) can be offered for sale for a contest/gaming transaction representative of one or more possible contest/event outcomes in block 304. When a participant purchases/accepts the transaction, the initial token cost 311, 311B (e.g., entry fee) can be immediately charged and held by the Smart Contract 302A, and a Game Token (e.g., Long-Term Win Token 1—304A, Long-Term win Token 2—304B) can be placed into the digital wallet (not shown) of the participant. A status 315, 315B (e.g., pending, won, lost, etc.) of the Long-Term game outcome tokens 304A, 304B for the contest/event can be included in the metadata of the Long-Term game outcome tokens 304A, 304B, in accordance with aspects of the present invention. The outcomes under which the holder of one or more Long-Term game Tokens 304A, 304B receives a payout 313, 313A for a win (or a limited or no payout for a loss) can be defined and governed by the Smart Contract by the payout/rules in block 303.

In some embodiments, once all of a threshold amount (e.g., 50%, 75%, 100%, etc.) of Long-Term game Tokens 304A, 304B have been purchased by users, and all entries fees have been paid to the Wallet 309, the Smart Contract 302A can be automatically activated and can confirm that the game is now active in block 306. Predetermined payout amounts from block 303 can be delivered by to one or more respective owners of one or more winning tokens upon satisfaction of predetermined conditions of the Smart Contract 302A, and if the predetermined conditions do not occur, the Smart Contract 302A can execute one or more other predetermined actions (e.g., no payout, less payout, etc.) according to the payout/rules in block 303, in accordance with aspects of the present invention.

In block 308, a current value of each of the Long-Term game outcome tokens 304A, 304B can be iteratively determined (e.g., based on determined probabilities, time left in season, injury to a player, etc.) during the contest/event, and a value of the Long-Term game outcome tokens 304A, 304B can be updated accordingly and the Long-Term win token initial value 308A, can further include a payout amount 319, an initial purchase price 317, and a designation of a winning result 321 (e.g., Shohei Otani hits more than 44 Home Runs). The initial token value 308A can be updated in block 308 to reflect a determined new token value 308B, which can include a payout amount 319B, an updated sale price 317B (e.g., higher or lower price than initial), and a designation of a winning result 321B (e.g., Yankees win), in accordance with aspects of the present invention.

In some embodiments, after the Smart Contract 302A is executed, each game token 304A, 304B can represent one or more attributes and/or outcomes which singularly or in combination with other game tokens can serve as entries into the contest. The game tokens 304A, 304B can be marketed/sold/transferred by their owners at any time, without limitation, during or before the contest/event, and an interface for marketing/selling/transferring game tokens 304A, 304B can be provided in block 310. The token marketing/selling/transferring interface of block 310 can enable a user/participant to sell their interest (e.g., game tokens 304A, 304B) before or during the related event. Since the Smart Contract 302A can exist on the blockchain, there can be a clear record of ownership of all game tokens 304A, 304B. Further, the attributes and/or outcome combinations which may (or may not) result in the owners of the game tokens 304A, 304B (or combination of game tokens 304A, 304B) receiving a payout upon outcome of the contest can be predefined by the Smart Contract 302A and thus known to users/participants upon entry into the contest, thereby increasing trust in the transactions.

In various embodiments, an outcome of the contest/event can be received by the Smart Contract 302A from a trusted authenticator (e.g., Oracle) in block 312. In some embodiments, trading and/or selling game tokens can be prevented/blocked by the terms of the Smart Contract 302A once the outcome of an event is confirmed. In block 314, upon the occurrence/satisfaction of a predefined trigger event (e.g., as defined in the Smart Contract 302A), winning token(s) and/or owners of winning token(s) can be determined as per the terms of the Smart Contract 302A, which may be less any transaction fee or service fee charged as part of the Smart Contract transaction. The Smart Contract 302A can execute the payout(s) or other contest prizes based on the event outcome. Payouts or contest prizes can be sent to the wallet (e.g., digital online wallet) that owns the winning Outcome Token(s) at this time, or can represent a right to claim such payout or represent the right to take some future action, in accordance with aspects of the present invention.

In some embodiments, metadata of the Game Tokens 304A, 304B can be updated upon occurrence/satisfaction of one or more trigger events to reflect current status 323, 323B (e.g., win, loss, paid, etc.) and/or payout amount 325, 325B for one or more winning tokens (e.g., Long-Term Win Token 1—314A, Long-Term Win Token 314B), in accordance with aspects of the present invention. In block 316, after the processing by the Smart Contract 302A is complete, the operator or Smart Contract 302A may record further updates to the metadata of the tokens 304A, 304B, and/or burn (e.g., invalidate, destroy, etc.) the game tokens 304A, 304B, 314A, 314B as a way to reflect and/or communicate the outcome of the game to participants.

In some embodiments, tokens 304A, 304B may also remain unchanged and can be used in other games by owners of the game tokens, in accordance with aspects of the present invention. It is noted that although the above-described method is illustratively depicted with respect to an Over/Under number of Home Runs during a MLB by Shohei Ohtani with two (2) tokens sold and utilized, it is to be appreciated that the present principles can be applied to any sort of long-term betting events (e.g., multiple game wins, one week long batting average, season long yards by an NFL quarterback, etc.) with any number of tokens sold and utilized, in accordance with various aspects of the present invention.

In accordance with aspects of the present invention, a calculation method for determining winning odds/probabilities can be executed for determining and/or updating the value of the Long-Term Win Tokens 304A, 304B for a long-term betting contest/gaming transaction during the event in block 308. It is noted that when two or more parties enter into a long-term bet, changing circumstances can constantly affect the value of the outcomes. Creating and/or utilizing an NFT to represent specific outcomes allow for owners/parties to offer/sell or bid/purchase specific outcomes as circumstances change over time in block 310. The below algorithm shows an exemplary calculation for such a determination, and can include value calculations for each outcome over time, given a specific set of circumstances.

The following example is presented for illustrative purposes, and is representative of an exemplary over/under bet for a threshold number (e.g., 44) of home runs hit in the 2022 MLB season by Shohei Ohtani. It can be assumed that at any point in time, the value of each outcome is:

Outcome Value=(Payout*Probability)

This can result in an initial bet creation with Odds 50% Over, and 50% Under. Generally, the oddsmakers will set a value of the over/under (e.g., 44) to the outcome they believe has exactly a 50% probability of occurring. In this example, it can be assumed that the over/under valuation is received from MGM Grand Sportsbook as follows:

Over Value=(2 ETH*50%)=1 ETH

Under Value=(2 ETH*50%)=1 ETH

In a circumstance in which after 40 games, Ohtani has only 8 Homeruns, while individuals may choose to evaluate such circumstances any number of ways, the present invention can accurately and efficiently determine probabilities and/or an updated token value by utilizing the initial over/under along with the number of games played to date to calculate an expected Home Run total, given the data through 40 games as follows:

$$H {R}_{E x pected} = \frac{44 H R}{162} = . 271 HR / game - HR rate expected for the player$$

$${HR}_{40} = \frac{8 H R}{40} = . 200 HR / game - HR rate through 40 games$$

$${HR}_{Over} = \frac{36 H R}{122} = . 295 HR / game - HR rate required to make the over with 122 games remaining$$

The above calculations can illustrate that the player is currently under-achieving and would need to significantly improve in the remaining games to reach the over (e.g., 44 HRs).

In a circumstance in which after 120 games, Ohtani now has overachieved and has a total of 40 Homeruns (with 43 games remaining), while individuals may again choose to evaluate such circumstances any number of ways, the present invention can accurately and efficiently determine probabilities and/or an updated value by utilizing the initial over/under along with the number of games played to date to calculate an expected Home Run total, given the data through 120 games as follows:

$$H {R}_{Expected} = \frac{44 H R}{162} = . 271 HR / game - HR rate expected for the player$$

$${HR}_{120} = \frac{40 HR}{120} = \text{.333} HR / game - HR rate through 120 games$$

$${HR}_{Over} = \frac{4 HR}{42} = \text{.095} HR / game - HR rate required to make the over with 43 games remaining$$

At this point, the player needs to hit just 4 Home Runs in his final 43 games to produce a winner (e.g., 44 or more HRs). Based on recent history for the player from the above calculations, this is very likely to occur and probabilities can be estimated as follows:

Estimates: Prₒᵥₑᵣ=90%, Pr_{Under}=10%

Updating the valuations in block 308 can result in:

Over Value=(2 ETH*90%)=1.80 ETH

Under Value=(2 ETH*10%)=0.20 ETH

It is noted that while the estimate of probabilities can vary based on individual opinions, mathematical models, etc. the value of the Over and Under tokens can vary based on the market estimates those probabilities. This can present a player with opportunities to buy-in to specific tokens when their own valuation calculation is greater than the market's valuation and/or the determined updated valuations in block 308, in accordance with aspects of the present invention. Such an ability to receive updated odds/probabilities during a gaming transaction and thus decide whether to trade or sell game tokens provides an advantage over conventional gaming systems and methods, in which a player is locked into a single outcome of All or Nothing (win or lose). In accordance with various embodiments, a participant in a contest/gaming transaction can have high flexibility to adjust betting during a contest, including, for example, a participant could take on additional risk by buying low probability tokens or hedge/reduce risk by selling their already owned high probability tokens for less than total payout, in accordance with various aspects of the present invention.

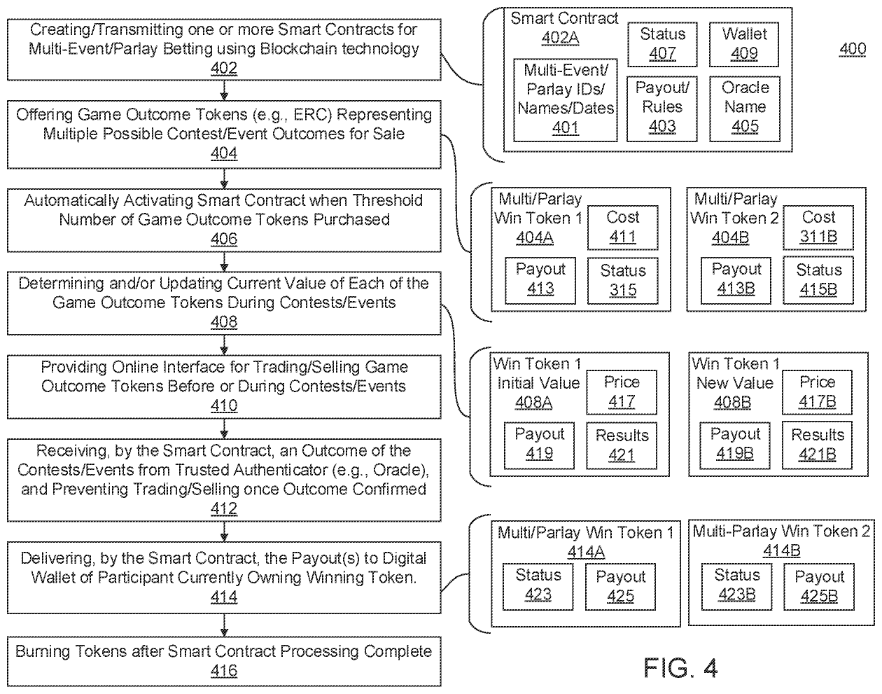

Referring now to FIG. 4, a block/flow diagram showing a method 400 for conducting and participating in online contests/gaming transactions with multi-event and/or parlay betting options with increased trust levels for users participating in the contests/gaming transactions using smart contracts and/or blockchain technology, is illustratively depicted in accordance with an embodiment of the present invention.

In an embodiment, a Smart Contract (e.g., ERC-721 token on the Ethereum network or similar) that defines the terms of the transaction can be created and/or transmitted to one or more contest participants for multiple-event and/or Parlay betting using blockchain technology in block 402.

For illustrative purposes, an exemplary Smart Contract 402A can include, for example, one or more of the following:
a. Event Details in block 401, which can include, for example:
   i. Event Dates and times: (e.g., Yankees v. Red Sox—8/8/2022, 8:00 pm EST, Mets v. Phillies—8-10-2022, 8:00 pm, Cubs v. Dodgers—8-12-2022, 8:00 pm.)
   ii. Type: (e.g., Parlay)
   iii. Parties: (e.g., Yankees, Red Sox, Mets, Phillies, Cubs, Dodgers);
b. Outcomes including payouts and contest rules in block 403, which can include, for example:
   i. Pick 1 of 3 winners
   ii. Pick 2 of 3 winners
   iii. Pick 3 of 3 winners
   iv. Canceled/Postponed (Each party returned its entry amount)
   v. Payout amount for winner (e.g., x Ethereum (ETH));
c. A trusted Authenticator of game results (e.g., Reference Oracle) in block 405, can be utilized for increasing trust in contest/gaming transactions between users, in accordance with aspects of the present invention. Oracles are data sources for a blockchain which support smart contract protocols (e.g., Ethereum) and can be referenced to determine if a predefined condition has been met, thus triggering and on-chain action. For example, prediction market applications can use oracles to determine whether a predetermined condition has been met for a particular event and/or group of events, and as a result settle payments based on the occurrence of the particular event(s). A prediction market may ask a user to bet Ethereum (ETH) on the election outcome for the next president of the United States, and can use an oracle (or other trusted authentication authority) to confirm the outcome and pay out to the winners. The outcome/payout can be specified in the smart contract 402A, and can execute upon satisfaction of one or more predetermined conditions, as specified by the Smart Contract 402A. An exemplary oracle 405 for the above baseball parlay betting example can be:
   i. MLB Individual Game Results Oracle;
d. A Smart Contract status in block 407, which can include, for example, designations such as offered contract, percentage of entries remaining, pending, paid, etc., in accordance with aspects of the present invention; and
e. Wallet holdings in block 409, which can represent a total amount of funding (e.g., ETH) required from users for entry into the contest/gaming transaction and can trigger the execution of the Smart Contract 402A when the total amount is reached, in accordance with aspects of the present invention.

In some embodiments, Multi-Event/Parlay game tokens 404A, 404B (e.g., ERC-721 tokens) can be offered for sale for a contest/gaming transaction representative of one or more possible contest/event outcomes in block 404. When a participant purchases/accepts the transaction, the initial token cost 411, 411B (e.g., entry fee) can be immediately charged and held by the Smart Contract 402A, and a Game Token (e.g., Multi-Event/Parlay win token 1—404A, Multi-Event/Parlay win token —404B) can be placed into the digital wallet (not shown) of the participant. A status 415, 415B (e.g., pending, won, lost, etc.) of the Multi-Event/Parlay win tokens 404A, 404B for the contest/event can be included in the Multi-Event/Parlay win tokens 404A, 404B, in accordance with aspects of the present invention. The outcomes under which the holder of one or more Multi-Event/Parlay win tokens 404A, 404B receives a payout 413, 413A for a win (or a limited or no payout for a loss) can be defined and governed by the Smart Contract 404A by the payout/rules in block 403. In some embodiments, the Smart Contract 404A can be designed and/or created either by a third-party operator or by one of the parties to a particular transaction (e.g., multi-event/parlay bet). In the example of a parlay bet, a participant (e.g., Party A) can choose what Party A believes will be winners of each of a plurality of events. In this illustrative embodiment, the Parlay token can win only if all events in a betting group (e.g., 3 events) are correctly picked, and another participant (e.g., Party B) can win if the outcome of any of the one or more event(s) is not correctly picked and won by Party A in accordance with aspects of the present invention.

In some embodiments, once all of a threshold amount (e.g., 50%, 75%, 100%, etc.) of Multi-Event/Parlay win tokens 404A, 404B have been purchased by users, and all entries fees have been paid to the Wallet 409, the Smart Contract 402A can be automatically activated and can confirm that the game is now active in block 406. Predetermined payout amounts from block 403 can be delivered by to one or more respective owners of one or more winning Multi-Event/Parlay game tokens upon satisfaction of predetermined conditions of the Smart Contract 402A, and if the predetermined conditions do not occur, the Smart Contract 402A can execute one or more other predetermined actions (e.g., no payout, less payout, etc.) according to the payout/rules in block 403, in accordance with aspects of the present invention.

In block 408, a current value of each of the Multi-Event/Parlay game tokens 404A, 404B can be iteratively determined (e.g., based on determined probabilities, time left in game, injury to a player, etc.) during the contest/event, and a value of the Multi-Event/Parlay game tokens 404A, 404B can be updated accordingly and the Multi-Event/Parlay game token initial value 408A, and can include a payout amount 419, an initial purchase price 417, and a designation of a winning result 421 (e.g., Correctly picked all 3 Parlay event winners). The initial Multi-Event/Parlay game token value 408A can be updated in block 408 to reflect a determined new Multi-Event/Parlay game token value 408B, which can include a payout amount 419B, an updated sale price 417B (e.g., higher or lower price than initial), and a designation of a winning result 421B (e.g., Correctly picked all 3 Parlay event winners), in accordance with aspects of the present invention.

In some embodiments, after the Smart Contract 402A is executed, each game token 404A, 404B can represent one or more attributes and/or outcomes which singularly or in combination with other game tokens can serve as entries into the contest. The game tokens 404A, 404B can be marketed/sold/transferred by their owners at any time, without limitation, during or before the contest/event, and an interface for marketing/selling/transferring game tokens 404A, 404B can be provided in block 410. The token marketing/selling/transferring interface of block 410 can enable a user/participant to sell their interest (e.g., Multi-Event/Parlay game tokens 404A, 404B) before or during the related event. Since the Smart Contract 402A can exist on the blockchain, there can be a clear record of ownership of all Multi-Event/Parlay game tokens 404A, 404B. Further, the attributes and/or outcome combinations which may (or may not) result in the owners of the Multi-Event/Parlay game tokens 404A, 404B (or combination of Multi-Event/Parlay game tokens 404A, 404B) receiving a payout upon outcome of the contest can be predefined by the Smart Contract 402A and thus known to users/participants upon entry into the contest, thereby increasing trust in the transactions.

In various embodiments, an outcome of the contest/event can be received by the Smart Contract 402A from a trusted authenticator (e.g., Oracle) in block 412. In some embodiments, trading and/or selling Multi-Event/Parlay game tokens can be prevented/blocked by the terms of the Smart Contract 402A once the outcome of an event or events is confirmed. In block 414, upon the occurrence/satisfaction of a predefined trigger event (e.g., as defined in the Smart Contract 402A), winning token(s) and/or owners of winning token(s) can be determined as per the terms of the Smart Contract 402A, which may be less any transaction fee or service fee charged as part of the Smart Contract transaction, in accordance with aspects of the present invention. In some embodiments, the Smart Contract 402A can either contact the Oracle to determine the outcome of the event(s), or can be provided the necessary outcomes to calculate the winning token or groups of tokens for the multi-event/parlay contest/gaming transaction 400, in accordance with aspects of the present invention. In some embodiments, payouts can be sent to the wallet (e.g., digital online wallet) that owns the winning Outcome Token at this time, or can represent the right for a future claim to such payout or rewards, in accordance with aspects of the present invention.

In some embodiments, metadata of the Game Tokens 404A, 404B can be updated upon occurrence/satisfaction of one or more trigger events to reflect current status 423, 423B (e.g., win, loss, paid, etc.) and/or payout amount 425, 425B for one or more winning tokens (e.g., Multi-Event/Parlay win token 1—414A, Multi-Event/Parlay win token 414B), in accordance with aspects of the present invention. In block 416, after the processing by the Smart Contract 402A is complete, the operator or Smart Contract 402A may record further updates to the metadata of the tokens 404A, 404B, and/or burn (e.g., invalidate, destroy, etc.) the game tokens 404A, 404B, 414A, 414B as a way to reflect and/or communicate the outcome of the game to participants. In some embodiments, tokens 404A, 404B may also remain unchanged and can be used in other games by owners of the game tokens, in accordance with aspects of the present invention. It is noted that although the above-described method is illustratively depicted with respect to a three (3) event parlay with two (2) tokens sold and utilized, it is to be appreciated that the present principles can be applied to any number and type of events with any number of tokens sold and utilized, in accordance with various aspects of the present invention.

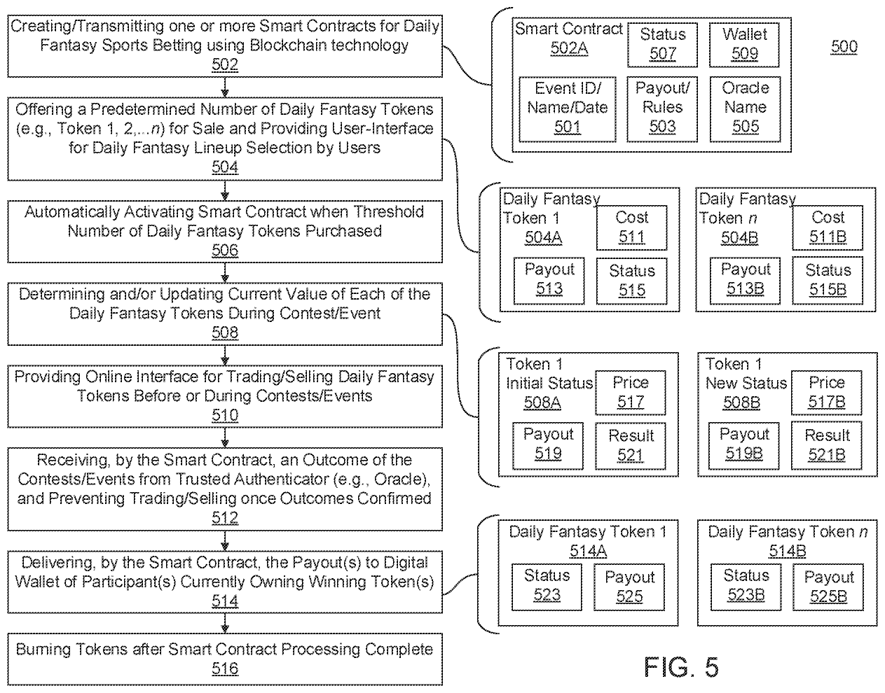

Referring now to FIG. 5, a block/flow diagram showing a method 500 for conducting online contests/gaming transactions with daily fantasy sports (e.g., fantasy football, fantasy baseball, etc.) betting options with increased trust levels using smart contracts and/or blockchain technology, is illustratively depicted in accordance with an embodiment of the present invention.

In an embodiment, a Smart Contract (e.g., ERC-721 token on the Ethereum network or similar) that defines the terms of the transaction can be created and/or transmitted to one or more contest participants for Daily Fantasy Sports (e.g., Fantasy Football) betting using blockchain technology in block 502.

For illustrative purposes, an exemplary Smart Contract 502A can include, for example, one or more of the following:
a. Event Details in block 501, which can include, for example:
   i. Event Dates and times: (e.g., NFL Daily Fantasy—2022 Week 1)
   ii. Type: (e.g., Daily Fantasy Football)
   iii. Parties: (e.g., NFL Teams and/or Players);
b. Outcomes including payouts and contest rules in block 503, which can include, for example:
   i. Top 3 participant fantasy scores receive payout (e.g., 50/30/20 for 1^{st}, 2^{nd}, 3^{rd}, respectively)
   ii. Top 10 participant fantasy scores receive payout
   iii. Bottom 10 participant fantasy scores receive payout iv. Any desired payout/triggering configurations as defined by the rules 503 of the Smart Contract 504A
   v. Payout amount for winner(s) (e.g., x Ethereum (ETH));
c. A trusted Authenticator of game results (e.g., Reference Oracle) in block 505, can be utilized for increasing trust in contest/gaming transactions between users, in accordance with aspects of the present invention. Oracles are data sources for a blockchain which support smart contract protocols (e.g., Ethereum) and can be referenced to determine if a predefined condition has been met, thus triggering and on-chain action. For example, prediction market applications can use oracles to determine whether a predetermined condition has been met for a particular event and/or group of events (e.g., scoring points in fantasy sports game), and as a result settle payments based on the occurrence of the particular event(s). A prediction market may ask a user to bet Ethereum (ETH) on the election outcome for the next president of the United States, and can use an oracle (or other trusted authentication authority) to confirm the outcome and pay out to the winners. The outcome/payout can be specified in the smart contract 502A, and can execute upon satisfaction of one or more predetermined conditions, as specified by the Smart Contract 502A. An exemplary oracle 505 for the above daily fantasy sports betting example can be:
   i. NFL Fantasy Football Weekly Oracle;
d. A Smart Contract status in block 507, which can include, for example, designations such as offered contract, percentage of entries remaining, pending, paid, etc., in accordance with aspects of the present invention; and
e. Wallet holdings in block 509, which can represent a total amount of funding (e.g., ETH) required from users for entry into the contest/gaming transaction and can trigger the execution of the Smart Contract 502A when the total amount is reached, in accordance with aspects of the present invention.

In some embodiments, Daily Fantasy game tokens 504A, 504B (e.g., ERC-721 tokens) can be offered for sale for a contest/gaming transaction representative of one or more possible contest/event outcomes in block 504. In some embodiments, Daily Fantasy game tokens 504A, 504B can be representative of individual players, and may be traded between participants using the online interface of block 510. When a participant purchases/accepts the transaction, the initial token cost 511, 511B (e.g., entry fee) can be immediately charged and held by the Smart Contract 502A, and a Game Token (e.g., Daily Fantasy token 1—504A, Daily Fantasy token n —504B) can be placed into the digital wallet (not shown) of the participant. A status 515, 515B (e.g., pending, won, lost, etc.) of the Daily Fantasy tokens 504A, 504B for the contest/event can be included in the Daily Fantasy tokens 504A, 504B, in accordance with aspects of the present invention. The outcomes under which the holder of one or more Daily Fantasy tokens 504A, 504B receives a payout 513, 513A for a win (or a limited or no payout for a loss) can be defined and governed by the Smart Contract 504A by the payout/rules in block 503. In some embodiments, the Smart Contract 504A can be designed and/or created either by a third part operator or by one of the parties to a particular transaction (e.g., Daily Fantasy sports bet). In the example of a Daily Fantasy sports bet, each participant/entrant can choose a daily/weekly fantasy sports lineup in block 504, and can pay for entry using, for example, Ethereum (ETH). The Smart Contract 504A can create a Daily Fantasy entry token 504A, 504B for each entrant and can hold the ETH in the Wallet 509 for payout to the winner(s).

In some embodiments, if at least all of a predetermined threshold number of participants (e.g., 5, 10, etc.) have selected Daily Fantasy tokens 504A, 504B before a deadline (e.g., predetermined time period), and all entries fees have been paid to the Wallet 509, the Smart Contract 502A can be automatically activated/executed and can confirm that the game is now active in block 506. Predetermined payout amounts from block 503 can be delivered by to one or more respective owners of one or more winning Daily Fantasy game tokens upon satisfaction of predetermined conditions of the Smart Contract 502A, and if the predetermined conditions do not occur, the Smart Contract 502A can execute one or more other predetermined actions (e.g., no payout, less payout, etc.) according to the payout/rules in block 503, in accordance with aspects of the present invention.

In block 508, a current value of each of the Daily Fantasy game tokens 504A, 504B can be iteratively determined (e.g., based on determined probabilities, time left in games, injury to a player, etc.) during the contest/event, a value of the Daily Fantasy game tokens 504A, 504B can be updated accordingly. The Daily Fantasy game token initial status 508A can include a payout amount 519, an initial purchase price 517, and a designation of a winning result 521 (e.g., 1^{st} place in Daily Fantasy, 2^{nd} place, etc.). The initial Daily Fantasy game token value 508A can be updated in block 508 to reflect a determined new Daily Fantasy game token status 508B, which can include a payout amount 519B, an updated sale price 517B (e.g., higher or lower price than initial), and a designation of a winning result 521B (e.g., 1^{st} place in Daily Fantasy, 2^{nd} place, etc.), in accordance with aspects of the present invention.

In some embodiments, after the Smart Contract 502A is executed, each Daily Fantasy game token 504A, 504B can represent one or more attributes and/or outcomes which singularly or in combination with other game tokens can serve as entries into the contest. The Daily Fantasy game tokens 504A, 504B can be marketed/sold/transferred by their owners at any time, without limitation, during or before the contest/event, and an interface for marketing/selling/transferring Daily Fantasy game tokens 504A, 504B can be provided in block 510. The Daily Fantasy token marketing/selling/transferring interface of block 510 can enable a user/participant to sell their interest (e.g., Daily Fantasy game tokens 504A, 504B) before or during the related event(s). Since the Smart Contract 502A can exist on the blockchain, there can be a clear record of ownership of all Daily Fantasy game tokens 504A, 504B. Further, the attributes and/or outcome combinations which may (or may not) result in the owners of the Daily Fantasy game tokens 504A, 504B (or combination of Daily Fantasy game tokens 504A, 504B) receiving a payout upon outcome of the contest can be predefined by the Smart Contract 502A and thus known to users/participants upon entry into the contest, thereby increasing trust in the transactions.

In various embodiments, an outcome of the contest/event can be received by the Smart Contract 502A from a trusted authenticator (e.g., Oracle) in block 512. In some embodiments, trading and/or selling Daily Fantasy game tokens can be prevented/blocked by the terms of the Smart Contract 502A once the outcome of an event or events is confirmed. In block 514, upon the occurrence/satisfaction of a predefined trigger event (e.g., as defined in the Smart Contract 502A), winning token(s) and/or owners of winning token(s) can be determined as per the terms of the Smart Contract 502A, which may be less any transaction fee or service fee charged as part of the Smart Contract transaction, in accordance with aspects of the present invention.

In some embodiments, the Smart Contract 502A can either contact the Oracle to determine the outcome of the event(s), or can be provided the necessary outcomes to calculate the winning token or groups of tokens for the Daily Fantasy contest/gaming transaction 500. In some embodiments, payouts can be sent to the wallet (e.g., digital online wallet) that owns the winning Outcome Token at this time, or can represent the right for a future claim to such payout or rewards, in accordance with aspects of the present invention.

In some embodiments, metadata of the Game Tokens 504A, 504B can be updated upon occurrence/satisfaction of one or more trigger events to reflect current status 523, 523B (e.g., win, loss, paid, etc.) and/or payout amount 525, 525B for one or more winning tokens (e.g., Daily Fantasy win token 1—514A, Daily Fantasy win token 514B), in accordance with aspects of the present invention. In block 516, after the processing by the Smart Contract 502A is complete, the operator or Smart Contract 502A may record further updates to the metadata of the tokens 504A, 504B, and/or burn (e.g., invalidate, destroy, etc.) the game tokens 504A, 504B, 514A, 514B as a way to reflect and/or communicate the outcome of the game to participants. In some embodiments, tokens 504A, 504B may also remain unchanged and can be used in other games by owners of the game tokens, in accordance with aspects of the present invention. It is noted that although the above-described method is illustratively depicted with respect to a Daily Fantasy sports game with a particular threshold amount of tokens sold to participants (e.g., 5, 10, etc.), it is to be appreciated that the present principles can be applied to any number and type of events with any number of tokens sold and utilized, in accordance with various aspects of the present invention.

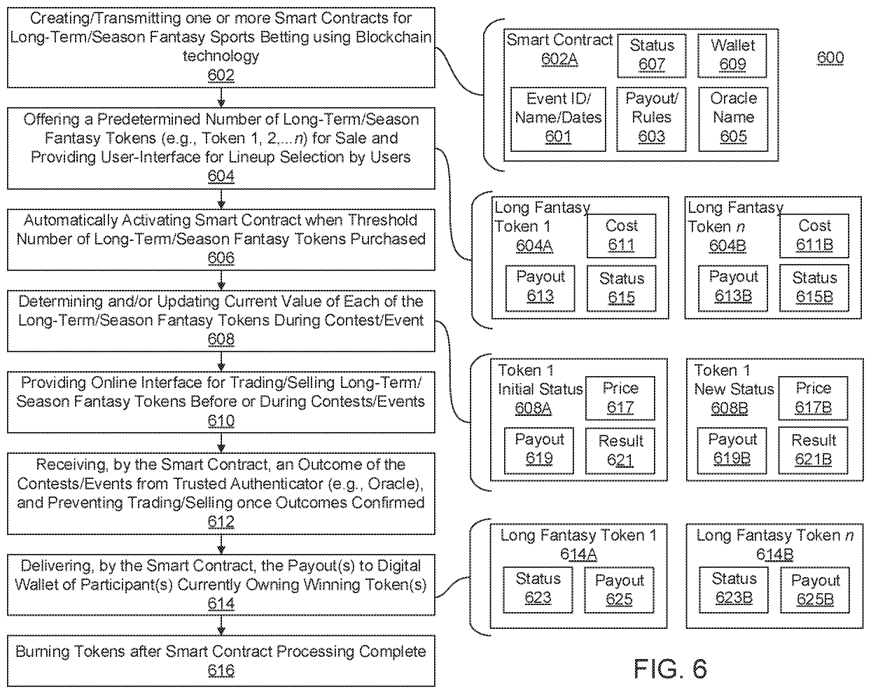

Referring now to FIG. 6, a block/flow diagram showing a method 600 for conducting online contests/gaming transactions with long-term (e.g., days, week, month, season, etc.) fantasy sports (e.g., fantasy football, fantasy baseball, etc.) betting options with increased trust levels using smart contracts and/or blockchain technology, is illustratively depicted in accordance with an embodiment of the present invention.

In an embodiment, a Smart Contract (e.g., ERC-721 token on the Ethereum network or similar) that defines the terms of the transaction can be created and/or transmitted to one or more contest participants for Long-Term (e.g., Season, Playoffs, multiple weeks, etc.) Fantasy Sports (e.g., Fantasy Football, Fantasy Baseball, etc.) betting using blockchain technology in block 602.

For illustrative purposes, an exemplary Smart Contract 602A can include, for example, one or more of the following:
a. Event Details in block 601, which can include, for example:
   i. Event Dates and times: (e.g., NFL Season-Long Fantasy—2022)
   ii. Type: (e.g., Season-Long Fantasy Football)
   iii. Parties: (e.g., NFL Teams and/or Players);
b. Outcomes including payouts and contest rules in block 603, which can include, for example:
   i. Top 3 participant fantasy scores receive payout (e.g., 50/30/20 for 1^{st}, 2^{nd}, 3^{rd}, respectively)
   ii. Top 10 participant fantasy scores receive payout
   iii. Bottom 10 participant fantasy scores receive payout
   iv. Any desired payout/triggering configurations as defined by the rules 603 of the Smart Contract 604A
   v. Payout amount for winner(s) (e.g., x Ethereum (ETH));
c. A trusted Authenticator of game results (e.g., Reference Oracle) in block 605, can be utilized for increasing trust in contest/gaming transactions between users, in accordance with aspects of the present invention. Oracles are data sources for a blockchain which support smart contract protocols (e.g., Ethereum) and can be referenced to determine if a predefined condition has been met, thus triggering and on-chain action. For example, prediction market applications can use oracles to determine whether a predetermined condition has been met for a particular event and/or group of events (e.g., scoring points in fantasy sports game), and as a result settle payments based on the occurrence of the particular event(s). A prediction market may ask a user to bet Ethereum (ETH) on the election outcome for the next president of the United States, and can use an oracle (or other trusted authentication authority) to confirm the outcome and pay out to the winners. The outcome/payout can be specified in the smart contract 602A, and can execute upon satisfaction of one or more predetermined conditions, as specified by the Smart Contract 602A. An exemplary oracle 605 for the above Long-Term fantasy sports betting example can be:
   i. NFL Fantasy Football Weekly Oracle;
d. A Smart Contract status in block 607, which can include, for example, designations such as offered contract, percentage of entries remaining, pending, paid, etc., in accordance with aspects of the present invention; and
e. Wallet holdings in block 609, which can represent a total amount of funding (e.g., ETH) required from users for entry into the contest/gaming transaction and can trigger the execution of the Smart Contract 602A when the total amount is reached, in accordance with aspects of the present invention.

In some embodiments, Long-Term Fantasy game tokens 604A, 604B (e.g., ERC-721 tokens) can be offered for sale for a contest/gaming transaction representative of one or more possible contest/event outcomes in block 604. In some embodiments, Long-Term Fantasy game tokens 604A, 604B can be representative of individual players, and may be traded between participants using the online interface of block 610. When a participant purchases/accepts the transaction, the initial token cost 611, 611B (e.g., entry fee) can be immediately charged and held by the Smart Contract 602A, and a Game Token (e.g., Long-Term Fantasy token 1—604A, Long-Term Fantasy token n —604B) can be placed into the digital wallet (not shown) of the participant. A status 615, 615B (e.g., pending, won, lost, etc.) of the Long-Term Fantasy tokens 604A, 604B for the contest/event can be included in the Long-Term Fantasy tokens 604A, 604B, in accordance with aspects of the present invention. The outcomes under which the holder of one or more Long-Term Fantasy tokens 604A, 604B receives a payout 613, 613A for a win (or a limited or no payout for a loss) can be defined and governed by the Smart Contract 604A by the payout/rules in block 603. In some embodiments, the Smart Contract 604A can be designed and/or created either by a third part operator or by one of the parties to a particular transaction (e.g., Long-Term Fantasy sports bet). In the example of a Long-Term Fantasy sports bet, each participant/entrant can choose a long-term (e.g., season, playoffs, multiple games, etc.) sports lineup in block 604 as specified by the rules 603 of the Smart Contract 602A, and can pay for entry using, for example, Ethereum (ETH). The Smart Contract 604A can create a Long-Term Fantasy entry token 604A, 604B for each entrant and can hold the ETH in the Wallet 609 for payout to the winner(s).

In some embodiments, if at least all of a predetermined threshold number of participants (e.g., 5, 10, etc.) have selected Long-Term Fantasy tokens 604A, 604B before a deadline (e.g., predetermined time period), and all entries fees have been paid to the Wallet 609, the Smart Contract 602A can be automatically activated/executed and can confirm that the game is now active in block 606. Predetermined payout amounts from block 603 can be delivered by to one or more respective owners of one or more winning Long-Term Fantasy game tokens upon satisfaction of predetermined conditions of the Smart Contract 602A, and if the predetermined conditions do not occur, the Smart Contract 602A can execute one or more other predetermined actions (e.g., no payout, less payout, etc.) according to the payout/rules in block 603, in accordance with aspects of the present invention.

In block 608, a current value of each of the Long-Term Fantasy game tokens 604A, 604B can be iteratively determined (e.g., based on determined probabilities, time left in season, injury to a player, etc.) during the contest/event, a value of the Long-Term Fantasy game tokens 604A, 604B can be updated accordingly. The Long-Term Fantasy game token initial status 608A can include a payout amount 619, an initial purchase price 617, and a designation of a winning result 621 (e.g., 1^{st} place in Long-Term Fantasy, 2^{nd} place, etc.). The initial Long-Term Fantasy game token value 608A can be updated in block 608 to reflect a determined new Long-Term Fantasy game token status 608B, which can include a payout amount 619B, an updated sale price 617B (e.g., higher or lower price than initial), and a designation of a winning result 621B (e.g., 1^{st} place in Long-Term Fantasy, 2^{nd} place, etc.), in accordance with aspects of the present invention.

In some embodiments, after the Smart Contract 602A is executed, each Long-Term Fantasy game token 604A, 604B can represent one or more attributes and/or outcomes which singularly or in combination with other game tokens can serve as entries into the contest. The Long-Term Fantasy game tokens 604A, 604B can be marketed/sold/transferred by their owners at any time, without limitation, during or before the contest/event, and an interface for marketing/selling/transferring Long-Term Fantasy game tokens 604A, 604B can be provided in block 610. The Long-Term Fantasy token marketing/selling/transferring interface of block 610 can enable a user/participant to sell their interest (e.g., Long-Term Fantasy game tokens 604A, 604B) before or during the related event(s). Since the Smart Contract 602A can exist on the blockchain, there can be a clear record of ownership of all Long-Term Fantasy game tokens 604A, 604B. Further, the attributes and/or outcome combinations which may (or may not) result in the owners of the Long-Term Fantasy game tokens 604A, 604B (or combination of Long-Term Fantasy game tokens 604A, 604B) receiving a payout upon outcome of the contest can be predefined by the Smart Contract 602A and thus known to users/participants upon entry into the contest, thereby increasing trust in the transactions.

In various embodiments, an outcome of the contest/event can be received by the Smart Contract 602A from a trusted authenticator (e.g., Oracle) in block 612. In some embodiments, trading and/or selling Long-Term Fantasy game tokens can be prevented/blocked by the terms of the Smart Contract 602A once the outcome of an event or events is confirmed. In block 614, upon the occurrence/satisfaction of a predefined trigger event (e.g., as defined in the Smart Contract 602A), winning token(s) and/or owners of winning token(s) can be determined as per the terms of the Smart Contract 602A, which may be less any transaction fee or service fee charged as part of the Smart Contract transaction, in accordance with aspects of the present invention.

In some embodiments, the Smart Contract 602A can either contact the Oracle to determine the outcome of the event(s), or can be provided the necessary outcomes to calculate the winning token or groups of tokens for the Long-Term Fantasy contest/gaming transaction 600. In some embodiments, payouts can be sent to the wallet (e.g., digital online wallet) that owns the winning Outcome Token at this time, or can represent the right for a future claim to such payout or rewards, in accordance with aspects of the present invention.

In some embodiments, metadata of the Game Tokens 604A, 604B can be updated upon occurrence/satisfaction of one or more trigger events to reflect current status 623, 623B (e.g., win, loss, paid, etc.) and/or payout amount 625, 625B for one or more winning tokens (e.g., Long-Term Fantasy win token 1—614A, Long-Term Fantasy win token 614B), in accordance with aspects of the present invention. In block 616, after the processing by the Smart Contract 602A is complete, the operator or Smart Contract 602A may record further updates to the metadata of the tokens 604A, 604B, and/or burn (e.g., invalidate, destroy, etc.) the game tokens 604A, 604B, 614A, 614B as a way to reflect and/or communicate the outcome of the game to participants. In some embodiments, tokens 604A, 604B may also remain unchanged and can be used in other games by owners of the game tokens, in accordance with aspects of the present invention. It is noted that although the above-described method is illustratively depicted with respect to a Long-Term Fantasy sports game with a particular threshold amount of tokens sold to participants (e.g., 5, 10, etc.), it is to be appreciated that the present principles can be applied to any number and type of events with any number of tokens sold and utilized, in accordance with various aspects of the present invention.

Referring now to FIG. 7, a diagram showing a system 700 for conducting and participating in online contests/gaming transactions with increased trust levels using smart contracts and/or blockchain technology, is illustratively depicted in accordance with an embodiment of the present invention.

In various embodiments, the system 700 can include a smart contract generator/execution device 702 for managing one or more contests/gaming transactions, and can include a contest outcome tokens generator 704, a smart contract activator and metadata updater 706, and a contest/game token (e.g., ERC-721) generator and purchase interface for participants 708, in accordance with aspects of the present invention. A token updated valuation determiner 710 can be utilized during a contest/gaming transaction to provide updated values of game tokens based on, for example, probabilities of various outcomes determined and/or communicated to participants during the contest/gaming transaction. An online token marketing, trading, and selling interface 712 can be utilized for transferring tokens between participants of the contest/gaming transactions. A trusted authenticator 714 (e.g., Oracle) can be utilized to determine contest results, and can communicate the results to a Smart Contract, which can distribute prizes to winners of the contest/gaming transaction in block 716. Online digital wallets 718 can be utilized by the Smart Contract and by the participants for payment of entry fees and delivering of prizes to one or more users and/or user devices 722, which can include one or more processor devices 724, and can be connected using a computing network and/or public or private blockchain 720 for conducting and participating in online contests/gaming transactions with increased trust levels using smart contracts and/or blockchain technology, in accordance with aspects of the present invention.

Referring now to FIG. 8, a diagram showing an exemplary high-level system and method 800 for conducting and participating in online contests/gaming transactions with increased trust levels using smart contracts and/or blockchain technology, is illustratively depicted in accordance with an embodiment of the present invention.

In some embodiments, a Smart Contract for contests/gaming transactions can be generated, transmitted, and or received using a computing device in block 802, and in block 804, the Smart Contract can be implemented on a public or private blockchain 806, in accordance with aspects of the present invention. One or more users and/or user devices 808, 810, 812, 814 can be operatively connected via any type of connection (e.g., wireless, wired, cellular, etc.) to the public or private blockchain to access the Smart Contract for participation in one or more contests/gaming transactions. Contest results can be determined by a trusted authenticator (e.g., oracle), and contest results can be output to the Smart Contract for further processing in block 816. The Smart Contract can determine winners and deliver prizes (e.g., deliver to participant's digital wallet) to the owners of winning tokens in block 818, and the tokens can be burned (e.g., destroyed, invalidated, etc.) or can remain unchanged in block 820, and thus can be used in other games by owners of the game tokens, in accordance with aspects of the present invention.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method for trusted gaming transactions using blockchain technology, comprising:
creating a smart contract defining terms of a particular gaming transaction using a blockchain;
activating the smart contract once a threshold amount of game tokens are purchased by participants;
providing a secure game token transferring interface and platform configured to utilize a blockchain protocol to verify ownership and authenticity of the game tokens prior to enabling transferring of the game token from one participant to another participant; and
monitoring a status of the event using the smart contract, and initiating a payout to a digital wallet of one or more winning participants by the smart contract upon the occurrence or non-occurrence of a triggering event.

2. The method as recited in claim 1, further comprising updating metadata of the game tokens once the smart contract is activated.

3. The method as recited in claim 1, wherein the blockchain protocol is centralized or decentralized.

4. The method as recited in claim 1, further comprising requesting, by the smart contract, event status results and calculations of contest results from a trusted third-party authenticator.

5. The method as recited in claim 1, further comprising invalidating all of the game tokens after the smart contract completes processing by initiating the payout.

6. The method as recited in claim 1, further comprising automatically initiating a request for a transfer of the game token upon a determined change in value of the game token reaching a predefined, participant-set threshold selling or buying price for the token.

7. The method as recited in claim 6, wherein the determined change in value is based on iteratively determining probabilities and updating odds of all potential outcomes in real-time during the gaming transaction.

8. A system for trusted gaming transactions using blockchain technology, comprising:
a processor device operatively connected to a computer-readable medium and configured to access a blockchain, the processor device being further configured for:
creating a smart contract defining terms of a particular gaming transaction using a blockchain;
activating the smart contract once a threshold amount of game tokens are purchased by participants;
providing a secure game token transferring interface and platform configured to utilize a blockchain protocol to verify ownership and authenticity of the game tokens prior to enabling transferring of the game token from one participant to another participant; and
monitoring a status of the event using the smart contract, and initiating a payout to a digital wallet of one or more winning participants by the smart contract upon the occurrence or non-occurrence of a triggering event.

9. The system as recited in claim 8, wherein the processor is further configured for updating metadata of the game tokens once the smart contract is activated.

10. The system as recited in claim 8, wherein the blockchain protocol is centralized or decentralized.

11. The system as recited in claim 8, wherein the processor is further configured for requesting, by the smart contract, event status results and calculations of contest results from a trusted third-party authenticator.

12. The system as recited in claim 8, wherein the processor is further configured for invalidating all of the game tokens after the smart contract completes processing by initiating the payout.

13. The system as recited in claim 8, wherein the processor is further configured for automatically initiating a request for a transfer of the game token upon a determined change in value of the game token reaching a predefined, participant-set threshold selling or buying price for the token.

14. The system as recited in claim 13, wherein the determined change in value is based on iteratively determining probabilities and updating odds of all potential outcomes in real-time during the gaming transaction.

15. A non-transitory computer readable storage medium comprising a computer readable program operatively coupled to a processor device for trusted gaming transactions using blockchain technology, wherein the computer readable program when executed on a computer causes the computer to perform the steps of:
creating a smart contract defining terms of a particular gaming transaction using a blockchain;
activating the smart contract once a threshold amount of game tokens are purchased by participants;
providing a secure game token transferring interface and platform configured to utilize a blockchain protocol to verify ownership and authenticity of the game tokens prior to enabling transferring of the game token from one participant to another participant; and
monitoring a status of the event using the smart contract, and initiating a payout to a digital wallet of one or more winning participants by the smart contract upon the occurrence or non-occurrence of a triggering event.

16. The non-transitory computer readable storage medium of claim 15, further comprising updating metadata of the game tokens once the smart contract is activated.

17. The non-transitory computer readable storage medium of claim 15, further comprising requesting, by the smart contract, event status results and calculations of contest results from a trusted third-party authenticator.

18. The non-transitory computer readable storage medium of claim 15, further comprising invalidating all of the game tokens after the smart contract completes processing by initiating the payout.

19. The non-transitory computer readable storage medium of claim 15, further comprising automatically initiating a request for a transfer of the game token upon a determined change in value of the game token reaching a predefined, participant-set threshold selling or buying price for the token.

20. The non-transitory computer readable storage medium of claim 19, wherein the determined change in value is based on iteratively determining probabilities and updating odds of all potential outcomes in real-time during the gaming transaction.
